(19) United States
(12) Patent Application Publication
(10) Pub. No.: US 2005/0071764 A1
(43) Pub. Date: Mar. 31, 2005

(54) Method for creating a collection of multimedia interactive graphic elements using arrow logic

(76) Inventor: Denny Jaeger, Oakland, CA (US)

Correspondence Address: Wilson & Ham;PMB: 348, 2530 Berryessa Road, San Jose, CA, 95132, US

(21) Appl. No.: 10/952,187

(22) Filed: Sep. 28, 2004

Related U.S. Application Data
(60) Provisional application No. 60/506,815, filed on Sep. 28, 2003.

(51) Int. Cl. H04N 5/91; H04N 7/04; H04N 7/06; H04N 7/08; H04N 7/52; G06F 3/00; G06F 17/00; G06F 9/00

(52) U.S. Cl. 715/731

(57) ABSTRACT

A method for creating a collection of interactive multimedia graphic elements, such as thumbnail images and sound switches, allows a user to associate graphic objects that represent multimedia files by drawing a graphic directional indicator, e.g., an arrow, in a computer environment to create the collection of interactive multimedia graphic elements. Each of the interactive multimedia graphic elements may be configured to perform an operation on the corresponding multimedia file, such as playing or displaying the file.

### REFERENCE TO RELATED APPLICATION

This application claims the benefit of U.S. provisional patent application Ser. No. 60/506,815, filed Sep. 28, 2003, the disclosure of which is incorporated herein by reference.

### FIELD OF THE INVENTION

The invention relates generally to computer operations, and more particularly to a method for creating a collection of multimedia graphic elements.

### BACKGROUND OF THE INVENTION

The widespread use of digital still and video cameras has increased demands for computer programs to manage, edit and/or present electronic media. Thumbnails provide an efficient means to present a large number of digital images to a viewer. Thumbnails are small images of original, larger images, which can be individually clicked on using a mouse to display the original image of that thumbnail image. Currently, there are a number of sophisticated graphics computer programs that allow users to create thumbnails.

Conventional graphics computer programs with a thumbnail creation feature typically require a user to learn complex procedures using one or more “pull-down” menus. Each menu may include a number of multi-tiered command items. In general, these command items and their locations do not follow any objective standard or logic, except that of the program manufacturer. In some programs, the menu offerings change depending on the task or item that has been selected. Thus, remembering the exact locations of the required command items to create thumbnails can be challenging to an average user. Furthermore, the procedure for creating thumbnails using a conventional graphics program is usually so different from other procedures that in-depth knowledge of these other procedures does not provide significant advantage in learning how to create thumbnails using the same graphics program.

In view of this concern, there is a need for a method for creating multimedia graphic elements, such as thumbnails, which is easy to perform by an average user.

### SUMMARY OF THE INVENTION

A method for creating a collection of interactive multimedia graphic elements, such as thumbnail images and sound switches, allows a user to associate graphic objects that represent multimedia files by drawing a graphic directional indicator, e.g., an arrow, in a computer environment to create the collection of interactive multimedia graphic elements. Each of the interactive multimedia graphic elements may be configured to perform an operation on the corresponding multimedia file, such as playing or displaying the file.

A method for creating a collection of interactive multimedia graphic elements comprising displaying graphic objects that represent multimedia files in a computer environment, drawing a graphic directional indicator in the computer environment, including associating the graphic objects with the graphic directional indicator, activating a transaction assigned to the graphic directional indicator, and creating the collection of interactive multimedia graphic elements in response to the activation of the transaction, each of the interactive multimedia graphic elements being configured to perform an operation on a corresponding multimedia file when activated.

An embodiment of the invention includes a storage medium, readable by a computer, tangibly embodying a program of instructions executable by the computer to perform method steps for creating and using a control text object.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1A depicts the creation of a collection of thumbnail pictures with the drawing of an arrow onscreen in accordance with an embodiment of the invention.

FIG. 1B depicts the creation of a collection of sound switches with the drawing of an arrow onscreen in accordance with an embodiment of the invention.

FIG. 2 is a flowchart of a process for creating a DSP switch in accordance with an embodiment of the invention.

FIGS. 3A and 3B show a flowchart of a process for creating a collection of switchable thumbnails or sound switches in accordance with an embodiment of the invention.

FIG. 4 is a flowchart of a process for creating a sound switch in accordance with an embodiment of the invention.

FIG. 5 is a flowchart of a process performed when a sound switch is activated or deactivated in accordance with an embodiment of the invention.

FIG. 6 is a flowchart of a process for creating a thumbnail picture in accordance with an embodiment of the invention.

FIG. 7 is a flowchart of a process performed when a thumbnail picture is clicked in accordance with an embodiment of the invention.

FIGS. 8A and 8B show a flowchart of a process for drawing an arrow in Blackspace environment and applying an arrow logic in accordance with an embodiment of the invention.

FIG. 9 is a process flow diagram of a method for creating a collection of interactive multimedia graphic elements in accordance with an embodiment of the invention.

### DETAILED DESCRIPTION

A method for creating a collection of interactive multimedia graphic elements, such as thumbnail images and sound switches, in accordance with an embodiment of the invention allows a user to associate graphic objects that represent multimedia files by drawing a graphic directional indicator, e.g., an arrow, in a computer environment to create the collection of interactive multimedia graphic elements. Instead of selecting commands from pull-down menus or the like, the method supports the creation of a collection of interactive multimedia graphic elements by graphical means, which does not utilize pull-down menus, task bars or the like.

In an exemplary embodiment, the method in accordance with the invention is executed by software installed and running in a computer. Thus, the method is sometimes referred to herein as the “software”. The method is described herein with respect to a computer operating environment referred to as the “Blackspace” environment. However, the invention is not limited to the Blackspace environment and may be implemented in a different computer operating environment. The word “Blackspace” is a trademark of the NBOR Corporation. The Blackspace environment presents one universal drawing surface that is shared by all graphic objects within the environment. The Blackspace environment is analogous to a giant drawing “canvas” on which all graphic objects generated in the environment exist and can be applied. Thus, the Blackspace environment is sometimes referred to herein as the Blackspace surface. Each of these graphic objects can have a user-created relationship to any or all the other objects. There are no barriers between any of the objects that are created for or exist on this canvas. User can create objects with various functionalities without delineating sections of screen space.

As mentioned above, the method is used to create a collection of interactive multimedia graphic elements, such as thumbnail images, sound switches or any other type of interactive multimedia graphic elements, e.g. video switches or digital signal processing (DSP) switches. A thumbnail image or picture is a graphically reduced copy of a picture. It occupies much less space in memory as it only contains enough data to show itself in this reduced size. As a result, it is quick to draw and manipulate. A thumbnail picture can own an “attached picture”. This is a normal picture object which typically uses the same media file as the thumbnail picture. A sound switch is a graphical switch, which is associated with a sound file. When the sound switch is “on”, the sound file can be replayed by the sound playback system. When the sound switch is “off”, the sound file is not reproduced when the sound system is in playback mode.

The creation of a collection of interactive multimedia graphic elements using the method in accordance with an embodiment of the invention involves the use of a particular arrow logic, the “create object collection” arrow logic. This arrow logic will associate a multimedia file type (e.g., jpg, wav, etc) with a switch or switchable object and its associated action, and allow the switch to perform an operation on the file for the user. This arrow logic can be stated as the following sentence: “The items that the arrow is drawn from, encircles, intersects, or nearly intersects (“intersects”) are turned into switches or switchable thumbnails in a VDACC object when the arrow is pointed to a blank Blackspace region.” The word “VDACC” is a trademark of the NBOR Corporation. A VDACC object is a display object that manages other graphic objects on a global drawing surface, e.g., the Blackspace surface. A VDACC object includes a workspace surface or canvas that may be larger than the visible or viewable area of the VDACC object. Thus, a VDACC object allows a user to scroll the visible area to view graphic objects or contents in the VDACC object that were hidden from the visible area. For more information on VDACC objects, see U.S. patent application Ser. No. 10/635,742, filed on Aug. 5, 2003, entitled “Intuitive Graphic User Interface with Universal Tools”, U.S. patent application Ser. No. 10/671,953, filed on Sep. 26, 2003, entitled “Intuitive Graphic User Interface with Universal Tools”, and PCT patent application no. PCT/US2004/025547, filed on Aug. 5, 2004, which are all incorporated herein by reference.

This arrow logic (referred to herein as the “orange arrow logic”) is associated with a drawing of an arrow of a particular color, e.g., orange, in the Blackspace environment by a user. The orange arrow can cause different types of results when it is used to intersect different types of media files. For instance, if the orange arrow, and its associated arrow logic, is used to intersect one or more sound files, these sound files are used to create sound switches—one switch for each sound file name that is intersected by the orange arrow. If, however, the orange arrow is used to intersect one or more picture files, these files are used to create switchable thumbnails—thumbnails that can be clicked on to cause an action. The more common action would be to cause a full-size picture of the thumbnail picture, to appear onscreen.

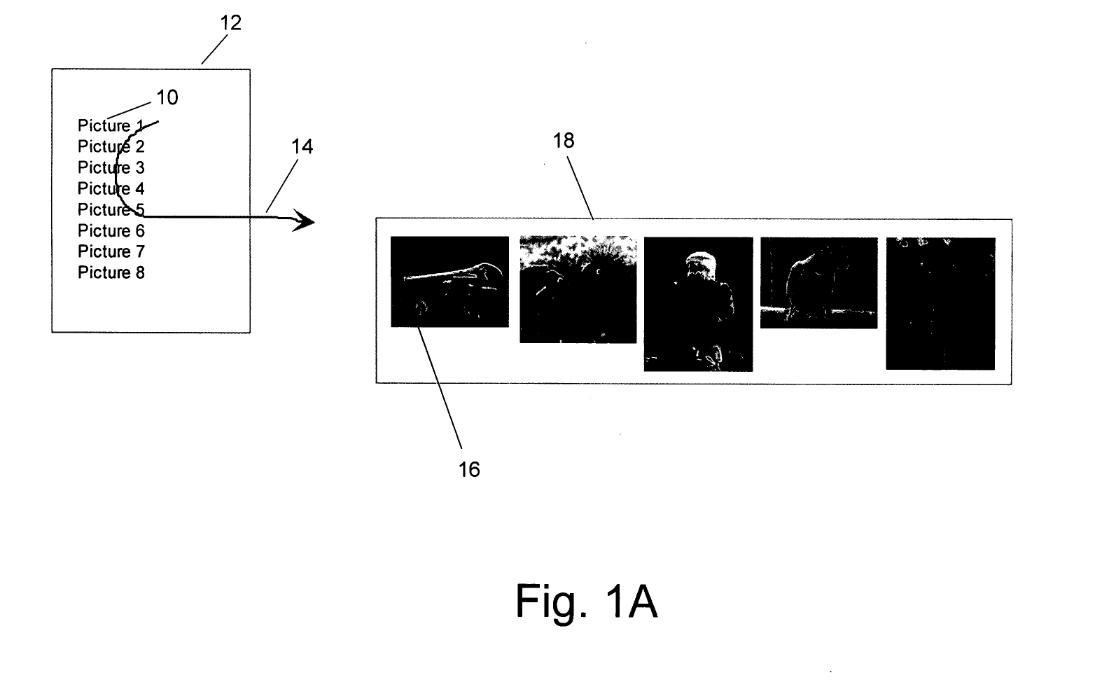

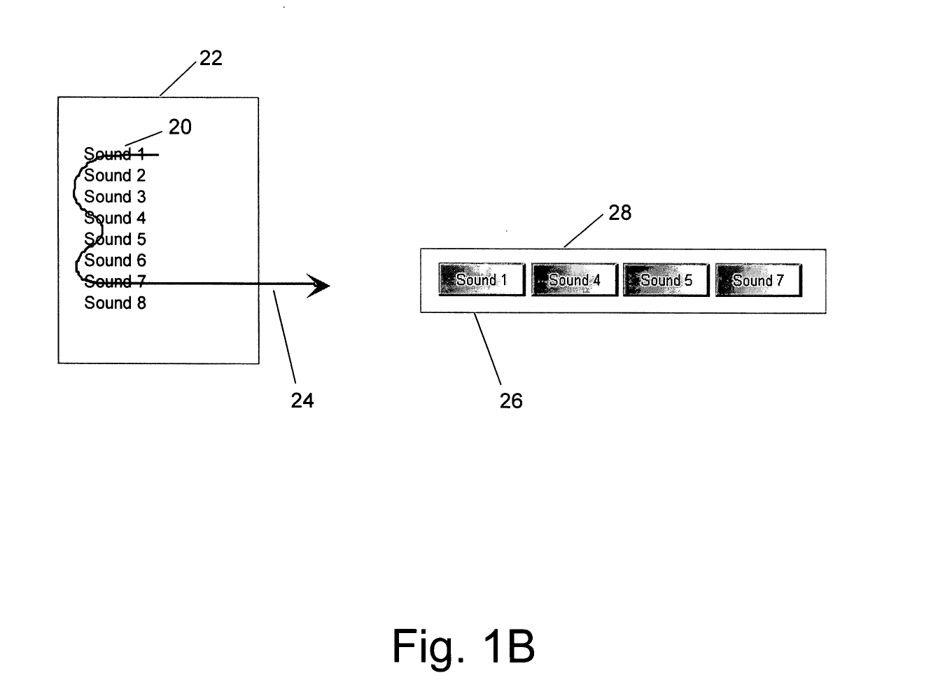

To utilize this arrow logic with pictures, a user may call forth a list of picture files 10 in a VDACC object 12, as illustrated in FIG. 1A. This may be achieved using the “specifier” feature of the Blackspace environment. In the Blackspace environment, various “known characters” are recognized as “specifiers”. These specifiers can be typed onscreen to initiate an action or call forth something that becomes visible onscreen. In this example, the list of picture files 10 in the VDACC object 12 can be made to appear onscreen by typing the letter “p”, which recalls the list of picture files saved on a media connected to the computer. Although the picture files 10 are located in the VDACC object 12 when recalled using the specifier feature, the picture files can then be placed anywhere onscreen.

After calling forth the list of picture files in the VDACC object 10, the user then draws an orange arrow 14 that intersects, encircles or nearly intersects (“intersects”) one or more picture files in the VDACC object or anywhere onscreen with the tip of the arrow pointing to a section of blank screen space, as shown in FIG. 1A. These pictures files could be a list of text, where each piece of text represents a different picture file. In the illustrated example, the orange arrow 14 is drawn to intersect five picture files, picture 1, picture 2, picture 3, picture 4 and picture 5. After drawing the arrow 14, if the software recognizes the drawing of the arrow, which has an orange arrow logic designated for it, and if this arrow (as drawn) has a valid source object and target object, the head of the orange arrowhead will turn color (e.g., white) or have some other appropriate graphic applied to it to visibly change its state. Other possibilities for this graphic would be pulsing the arrowhead, or flashing it, or changing it to another color, etc. When the user clicks on the orange arrow's arrowhead, the orange arrow logic creates thumbnails 16 of the pictures represented by the picture files that were “intersected” by the arrow 14. As illustrated in FIG. 1A, the thumbnails 16 may be placed in a new VDACC object 18 for convenience. Each of the thumbnails appears as portrait, landscape or square aspect ratios depending upon the format of each picture that each thumbnail is referring to. The order of thumbnails displayed in the new VDACC object 18 may depend on the order in which the associated picture files 10 were “intersected” by the orange arrow 14.

Once these thumbnails 16 are created, activating any thumbnail (e.g., left-clicking on it) will cause a full size picture of the associated picture file to appear onscreen.

Note: the orange arrow logic does not require a target object, so drawing an orange arrow so its tip points to blank screen space will create a valid orange logic, as far as its requirement for a target object is concerned. Regarding valid source objects, the shaft of the orange arrow can intersect, sound files, DSP devices, picture files, video files and other types of media files and operational devices.

To utilize the orange arrow logic with sound files, a user may call forth a list of sound files 20 in a VDACC object 22, as illustrated in FIG. 1B. This may again be achieved using the “specifier” feature of the Blackspace environment. In this example, the list of sound files 20 in the VDACC object 22 can be made to appear onscreen by typing the letter “s”, which recalls the list of sound files saved on a media connected to the computer. Although the sound files 20 are located in the VDACC object 22 when recalled using the specifier feature, the sound files can then be placed anywhere onscreen.

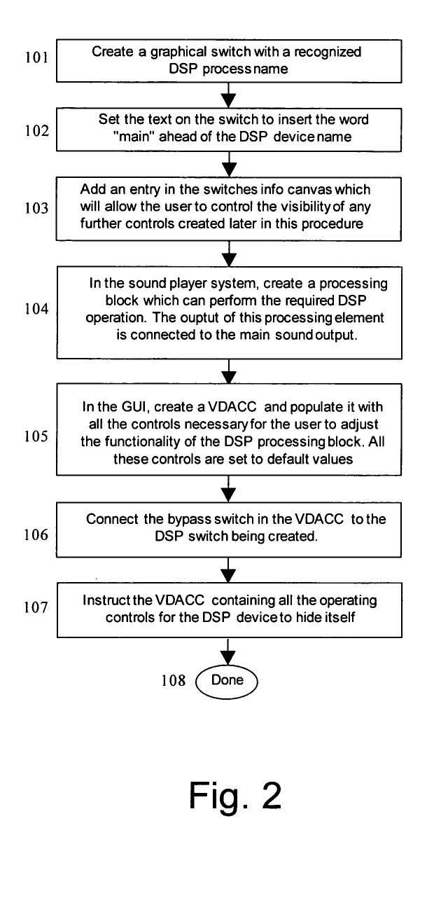

After calling forth the list of sound files 20 in the VDACC object 22, the user then draws an orange arrow 24 that intersects, encircles or nearly intersects (“intersects”) at least one sound file in the VDACC object or anywhere onscreen and then has the tip of the arrow pointing to a section of blank screen space, as illustrated in FIG. 2. These sound files 20 could be a list of text, where each piece of text represents a different sound file. After drawing the arrow 24, if the software recognizes the drawing of the arrow, which has an orange arrow logic designated for it, and if this arrow (as drawn) has a valid source object and target object, the head of the orange arrowhead will turn color (e.g., white) or have some other appropriate graphic applied to it to visibly change its state. When the user clicks on the orange arrow's arrowhead, the orange arrow logic creates a sound switch 26 for each sound file that is intersected by the orange arrow. As illustrated in FIG. 2, the sound switches 26 may be placed in a new VDACC object 28 for convenience. The order of sound switches displayed in the new VDACC object 28 may depend on the order in which the associated sound files were “intersected” by the orange arrow 24.

Once these sound switches 26 are created, activating any sound switch (e.g., left-clicking on it) will cause the sound file associated with that switch to be turned on, so it can be played. Turning off any sound switch 26 will result in the sound file controlled by that sound switch being muted so it cannot be played.

NOTE: For more information pertaining to arrow and arrow logics please refer to pending U.S. patent application Ser. No. 09/880,397, filed Jun. 12, 2001, entitled “Arrow Logic System for Creating and Operating Control Systems”, and pending U.S. patent application Ser. No. Ser. No. ______, filed Sep. 13, 2004, entitled “Method for Creating User-Defined Computer Operations Using Arrows”, which are both incorporated herein by reference.

With reference to the flowchart of FIG. 2, the process of creating a DSP switch in accordance with an embodiment of the invention is described. A DSP switch is a graphical switch which is associated with a sound processing element in a sound record/playback system. When the switch is ON, the DSP element is active. When the switch is OFF, the DSP element is deactivated or bypassed and performs no operations on any incoming audio signal.

Block 101. When the user creates a switch in the GUI, he can immediately type a name onto the switch surface. If the sound system recognizes this name as the name of a DSP process, such as delay, eq, reverb, etc., then this procedure is invoked to add the appropriate functionality to the switch.

Block 102. The word “Main” is added to the switch text to indicate that the DSP device is allocated to the main sound output channel until it is re-assigned in the signal processing chain by other user actions.

Block 103. The software adds a dynamic entry into the Info Canvas object for the DSP switch that allows the user to determine whether the DSP controls are visible onscreen or remain invisible.

Block 104. In the sound player software a processing block is created that can perform the required DSP operation as defined by the DSP switch. The output of this processing block (element) is connected to the main sound output.

Block 101. In the GUI the software creates a VDACC object and in this VDACC object are placed all of the controls necessary to operate the DSP device controlled by the DSP switch. All of these DSP controls are set to default values, but they can be changed at any time by the user.

A DSP device will have a number of parameters which can usefully be adjusted by the user, e.g., delay time in a delay process or high frequency boost in an equalizer. A collection of faders, knobs, switches, labels and other graphic devices can be placed into the VDACC object to control and display the state of all these parameters.

Block 106. The software connects a bypass switch in the VDACC object to the DSP switch that is being created.

All DSP devices have one feature in common. The ability to be bypassed, or switched off. When they are switched off, no processing of the audio signal is performed and the input signal is passed unmodified directly to the output. If the VDACC object contains a bypass switch to achieve this functionality, it is connected to the main DSP switch which is being created in this flowchart. When the DSP switch is turned ON, the bypass switch is automatically turned OFF, and vice versa.

Block 107. The software instructs the VDACC object, which contains all of the controls for operating the DSP device, to hide itself—become invisible.

Block 108. The process ends.

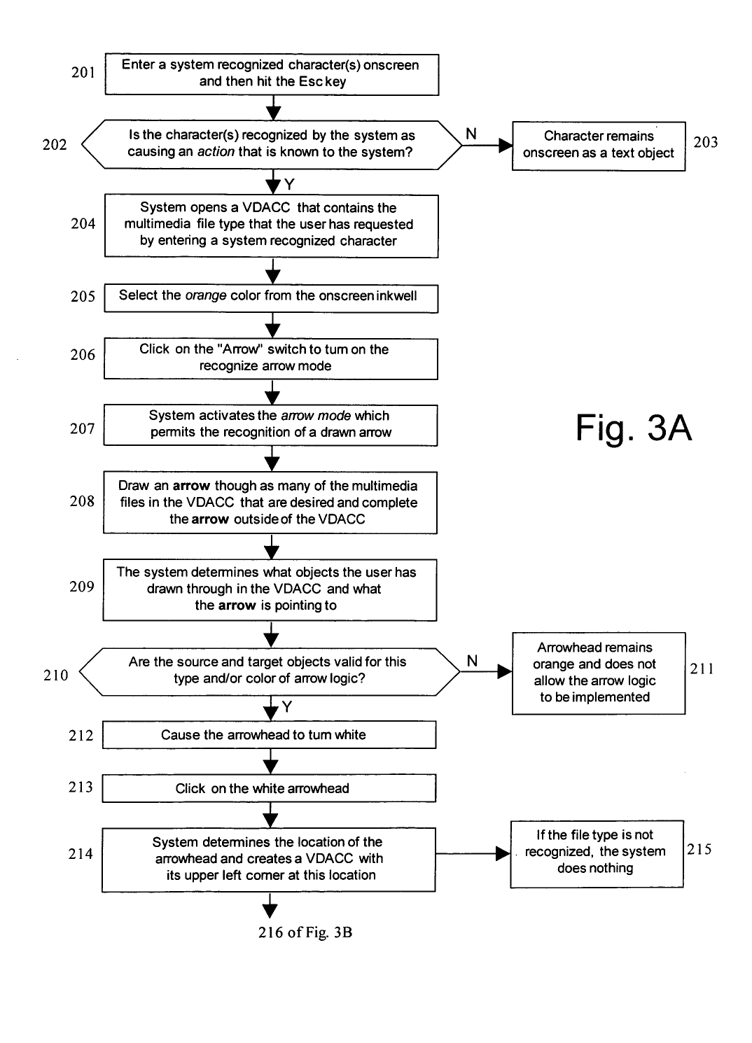

A process for creating a collection of switchable thumbnails or sound switches in accordance with an embodiment of the invention is now described with reference to a flowchart shown in FIGS. 3A and 3B.

Block 201. The software recognizes various characters, which are referred to as “known characters.” These known characters are also referred to as “specifiers.” These specifiers can be typed onscreen to initiate an action or call forth something that becomes visible onscreen. Examples of specifiers include the following:
A. Typing the letter “s” to recall a list of sound files saved on a media connected to a computer. This media can include hard drives, CDs, external drives, DVDs, etc.
B. Typing the letter “p” to recall a list of picture files saved on a media connected to a computer.
C. Typing the letters “ev” to recall a list of Event Dyomations saved on a media connected to a computer.
D. Typing the letters “dm” to recall a list of Object Dyomations saved on a media connected to a computer.

A typical character that could be typed at Block 201 of this flowchart would be a “p” to recall a list of pictures or an “s” to recall a list of sound files.

Block 202. The software checks to see if the typed character(s) are recognized. In other words, if they represent or call forth a known action or function or the like for the software.

Block 203. If the character(s) that are typed are not recognized, then the character(s) will remain onscreen as a text object and no action or the like will be initiated by the typing of this character(s).

Block 204. If the character(s) are recognized, then the action/function and the like associated with that character(s) will be initiated. For instance, if a “p” were typed, it would be recognized by the software and a VDACC object would appear showing a list of picture files stored on media connected to the computer. If an “s” was typed, then a VDACC object would appear showing a list of sound files stored on media connect to the computer.

Block 205. The user selects the color orange from an inkwell visible onscreen. This color orange has the “orange” arrow logic designated for it.

Block 206. The user activates the “arrow” mode.

Block 207. The software activates its ability (the arrow mode) to permit the recognition a hand drawn input as an arrow.

Block 208. The user draws an arrow which intersects various multimedia files in the list of media and then points the arrow outside the VDACC object which contains the list of media.

Block 209. The media files that are intersected by the shaft of the arrow are entered into the source object list for the drawn and recognized orange arrow. The tip of the arrow is pointed to blank screen space. NOTE: the use of specifiers is not the only method to utilize the orange arrow and its designated arrow logic. Objects could be present onscreen that represent media files where they were not accessed via a specifier. For instance, they could have been directly typed by name or recalled verbally or by some other method. Also the presence of such media files could have been saved as part of a log, thus when the log was recalled, these media files were present onscreen without the user having to recalled them individually.

Block 210. The software determines if the objects in the source object list for the drawn and recognized orange arrow are valid. The software also determines if the target object is valid. In the case of an orange arrow logic, no target object is required, so pointing the orange arrow to blank screen space is a valid “target” for the orange “create object collection” arrow logic.

Block 211. If the source and “target” objects are not valid, then the arrowhead remains orange and the orange arrow logic is not implemented. If the hand drawn arrow is properly drawn, it is recognized by the software, but since the arrow logic designated for this arrow (the orange logic) has either an invalid source or target or both, the drawn and recognized arrow remains onscreen as a graphic arrow only.

Block 212. If the source and target objects are valid for this type of arrow logic, in other words, if the source and target objects are valid for the orange arrow, then the arrowhead for the orange arrow turns white. This indicates to the user that the arrow logic is valid and is ready for activation. Other types of visual indicators are possible. For instance, the arrowhead could start pulsating or it could change its size and the like.

Block 213. The user clicks on the white arrowhead of the drawn and recognized orange arrow and this action activates the arrow logic designated for that arrow—the orange arrow logic.

Block 214. The software determines the pixel location of the tip of the white arrowhead. The arrow disappears from onscreen and a VDACC object is created where the upper left corner of the VDACC object is located at the pixel corresponding to the location of the tip of the white arrowhead. This is an arbitrary decision for the software and can be changed to be any location desired. This can be a user designated location where the user could select an X and Y coordinate in a menu or it can be a software embedded location which could act as a software default.

Block 215. If the character(s) that were typed under Block 202 call forth a file type that is not recognized by the software, no action is taken.

Block 216. If the file type is recognized by the software, then the software checks to see what the file type is. The orange arrow causes different actions depending upon the file type that comprises its source object(s). In other words, the resulting action of the orange arrow logic is dependent upon the file type that is intersected by the shaft of the drawn and recognized orange arrow. The software checks to see if this file type is a sound file.

Block 217. If yes, then the software creates a sound switch for each sound file in the source object list for the drawn and recognized orange arrow. Each sound switch represents each sound file in this source object list.

Each of these sound switches can be used to play the sound file associated with it. One method of doing this would be to activate a Play action. A user can do this by turning on a play switch or by a verbal command or some other suitable method. Then with the play action activated, any sound switch that is turned on, will enable its sound to be played back. Turn off that sound switch and its sound will no longer be audible. In other words, the sound switches act as “mute” switches, which are common in the art for recording consoles and recording equipment.

It should be noted here that if a sound switch is dragged to intersect a time line, a play bar can be automatically created along that time line for the sound file that belongs to that sound switch. Then the audio file can be edited on the time line and the sound switch still acts as a “mute” control for that sound file. For more information about time line, see pending U.S. patent application Ser. No. 10/635,747, filed Aug. 5, 2003, entitled “Method for Creating and Using Time Line and Play Rectangles,” which is incorporated herein by reference.

Block 218. Once the sound switches are created, they are placed into a VDACC object. This VDACC object acts as a convenient vehicle for containing the sound switches. This container can be used to easily move the sound switches as a group around the screen. The VDACC object also enables a user to change its size so its takes up less screen space.

Block 219. If the file type is not a sound file, then the software checks to see if the file type is a picture file.

Block 220. If yes, then a thumbnail picture is created for each picture file in the source object list for the drawn and recognized orange arrow. This thumbnail picture supports a switchable action. In other words, clicking on any thumbnail picture permits the original image that the thumbnail represents to appear onscreen. The longer dimension of the original picture is reduced to a specific size (set in the software). This size is used to calculate the landscape, portrait or square orientation of each thumbnail for each picture that it represents.

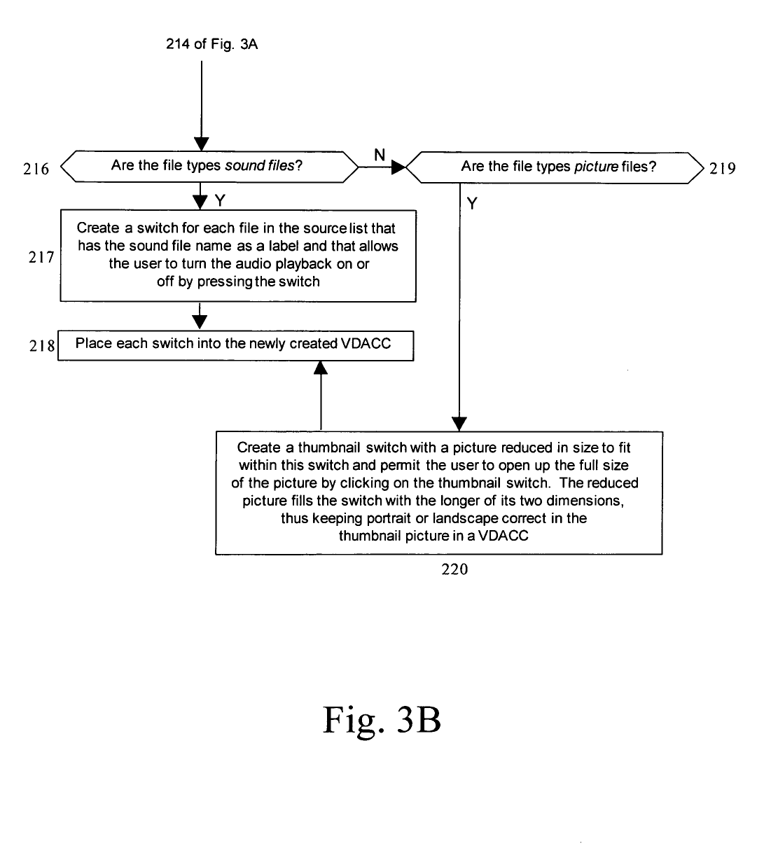

With reference to the flowchart of FIG. 4, a process for creating a sound switch in accordance with an embodiment of the invention is described. This process may be performed at Block 217 in the flowchart of FIG. 3B.

Block 301. The user creates a graphical switch or it is created automatically by the software, e.g., as part of a default load process or as part of the orange arrow process.

Block 302. A name of a sound file is input for the switch. One method of accomplishing this is to type the name of the sound file onto the switch. Another method would be to verbally input the name of this sound file after first selecting the switch. Other methods of input are possible.

Block 303. The software then informs the playback system that a new sound file has been recalled and this switch will control its operation.

Block 304. The process ends.

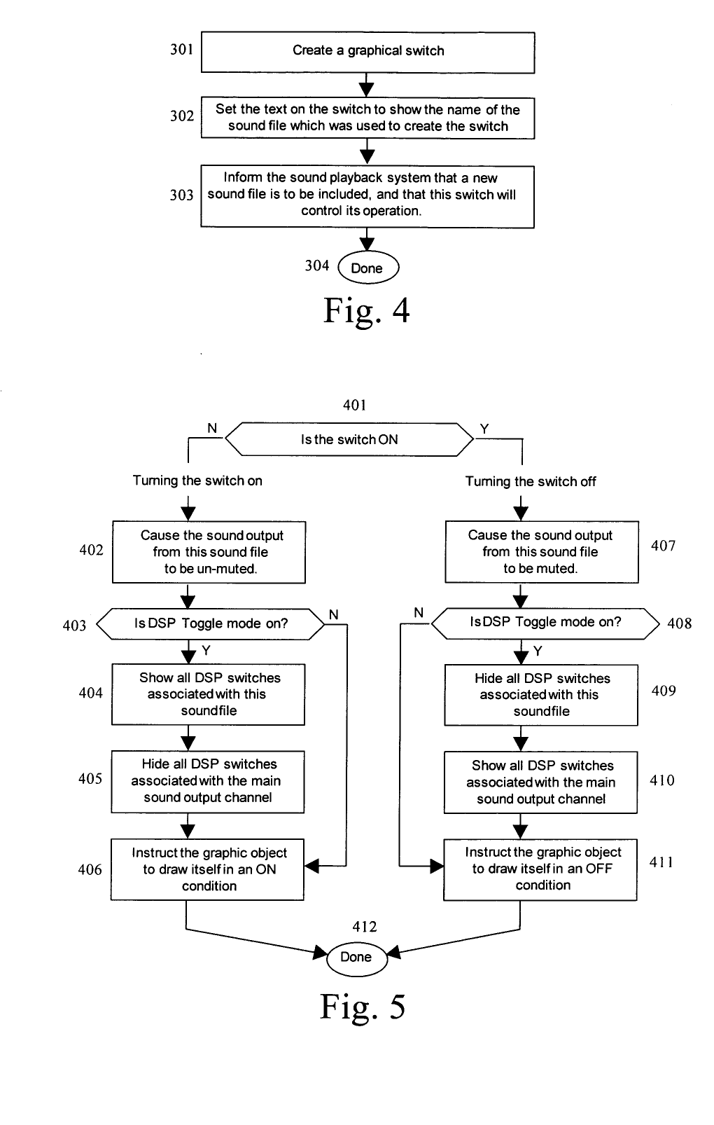

With reference to the flowchart of FIG. 5, a process performed when a sound switch is activated or deactivated in accordance with an embodiment of the invention is described.

Block 401. The on/off status of the sound switch is determined. If the status is “off,” the sound switch is then turned on.

Block 402. The output of the sound file, for which this switch represents and controls, is un-muted. The user would likely see the switches status change. For instance, an un-muted sound switch could appear to be unpressed or its color could change from gray (muted) to green (un-muted).

Block 403. The software checks to see if the DSP “Toggle” mode is on. If a sound switch is not part of the TEHO system, then this step can be bypassed. The “TEHO” is a trademark of NBOR Corporation. For information about TEHO system and DSP switches, see simultaneously filed U.S. Patent Application Ser. No. ______, entitled “Method and Apparatus for Performing Multimedia Operations,” which is incorporated herein by reference.

If the DSP “Toggle” mode is on, then the process proceeds to Block 404. If the DSP “Toggle” mode is not on, then the process proceeds to Block 406.

Block 404. If yes, then all DSP switches that are associated with this sound file are shown onscreen. DSP switches can be associated with a sound switch for various reasons. Two reasons are:
(a) The sound switches sound file can be sent to one or more DSP devices that are controlled by one or more DSP switches.
(b) The sound switches sound file can be the input to an audio channel where the DSP devices controlled by one or more DSP switches can be the processing for that audio channel.

Block 405. All DSP switches that are associated with the main sound output channel are hidden and in their place all DSP switches that are associated with the sound switch remain onscreen. This lets the user gain easy access to the DSP processing for the sound file that is represented by the sound switch. It also provides the user with an easy toggle action to show either the DSP processes for one or more sound switches or the DSP processes for the main sound output channel. The main sound output channel can be like the master output on a recording console. As such, it would serve the purpose of being the final processing and mixing channel for an audio console, as supported in the TEHO system.

Block 406. The software instructs the sound switch to change its appearance to show an “on” status for the switch. This could be shown by changing the color of the switch from gray (off) to green (on) or the switch could go from being undepressed (off) to being depressed (on) or the like. The process then comes to an end.

Block 407. If, at Block 401, the sound switch was on, the output of the sound file, for which this switch represents and controls, is muted. The user would likely see the switches status change.

Block 408. The software checks to see if the DSP “Toggle” mode is on.

If the DSP “Toggle” mode is on, then the process proceeds to Block 409. If the DSP “Toggle” mode is not on, then the process proceeds to Block 411.

Block 409. If yes, then all DSP switches that are associated with this sound file are hidden.

Block 410. All DSP switches that are associated with the main sound output channel are shown.

Block 411. The software instructs the sound switch to change its appearance to show an “off” status for the switch.

Block 412. The process ends.

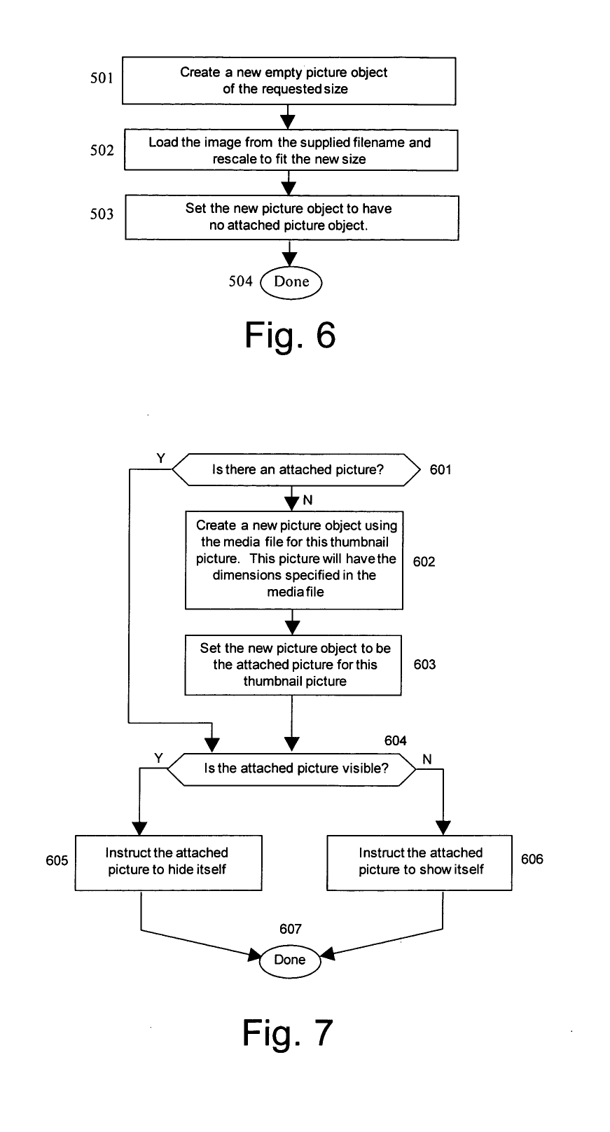

With reference to the flowchart of FIG. 6, a process for creating a thumbnail picture in accordance with an embodiment of the invention is described. This process may be performed at Block 220 of FIG. 3B.

Block 501. The software creates a new empty picture object of a requested size. The orange arrow software requests thumbnails that are of a certain default size. This size can be changed in software to a different default if needed.

Block 502. The image that has been selected, e.g., from a picture file list, is loaded into the new empty picture object and it is rescaled to fit the “requested size” of this picture object.

Block 503. A thumbnail picture has an attached picture, which is a full scale version of the picture that the thumbnail represents. When a thumbnail is first created, this attached picture is not created with it. One reason for this approach is to save memory. A thumbnail may be used to supply a quick view of files on disk without having to see the full image. So creating just thumbnails saves memory. This approach is optional. The software could create both thumbnails and the attached pictures simultaneously if memory is not an issue.

Block 504. The process ends.

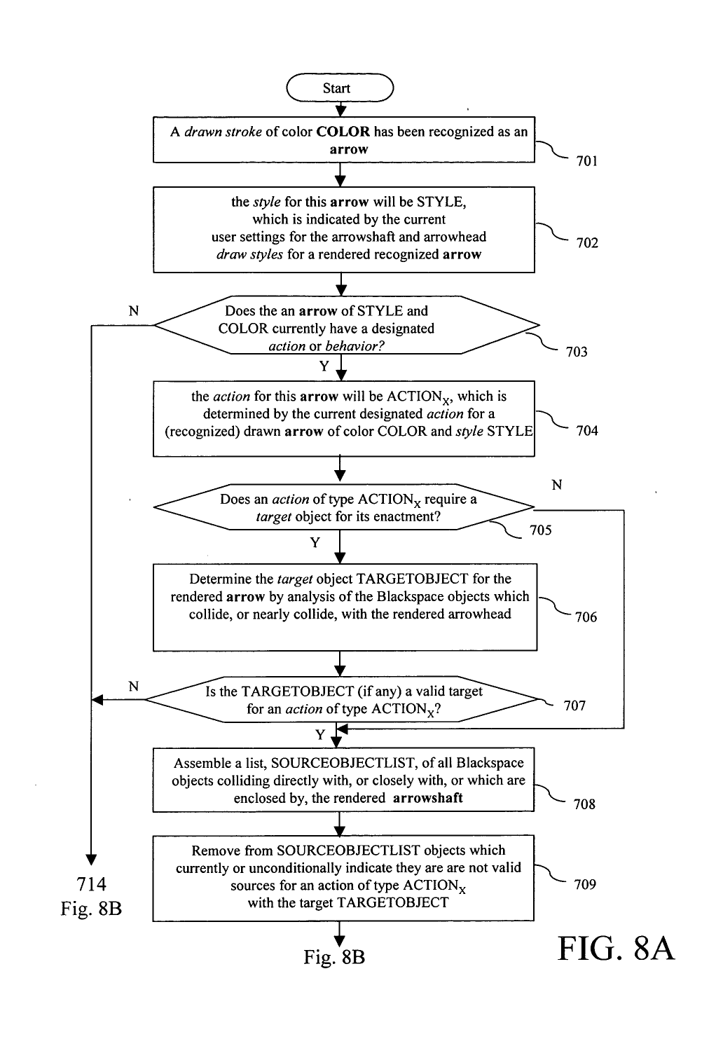

With reference to the flowchart of FIG. 7, a process performed when a thumbnail picture is clicked in accordance with an embodiment of the invention is described.

Block 601. The software checks to see if the thumbnail has an attached picture. If no, the process proceeds to Block 602. If yes, the process proceeds to Block 604.

Block 602. The software creates a new picture object using the media file that this thumbnail picture represents. This attached picture will have the dimensions of the media file. This includes all dimensional properties of this media file, e.g., is it landscape, portrait or square and what is its height and width.

Block 603. This new picture object is allocated to be the attached picture for this thumbnail.

Block 604. The software checks to see if this attached picture is visible onscreen. If yes, the process proceeds to Block 605. If no, the process proceeds to Block 606.

Block 605. The software instructs the attached picture to become invisible onscreen. The process then comes to an end.

Block 606. The software instructs the attached picture to become visible onscreen.

Block 607. The process ends.

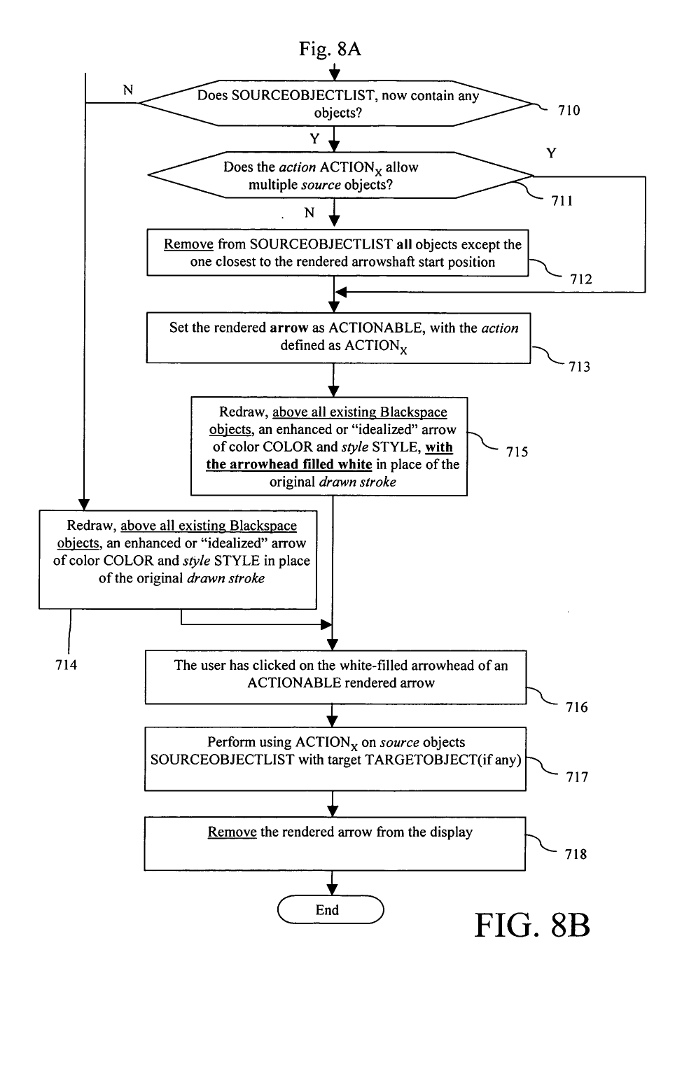

With reference to the flowchart of FIGS. 8A and 8B, the process for drawing an arrow in Blackspace environment and applying an arrow logic in accordance with an embodiment of the invention is now described.

Block 701. A drawn stroke of color “COLOR” has been recognized as an arrow—a mouse down has occurred, a drawn stroke (one or more mouse movements) has occurred, and a mouse up has occurred. This stroke is of a user-chosen color. The color is one of the factors that determine the action (“arrow logic”) of the arrow. In other words, a red arrow can have one type of action (behavior) and a yellow arrow can have another type of action (behavior) assigned to it.

Block 702. The style for this arrow will be “STYLE”—This is a user-defined parameter for the type of line used to draw the arrow. Types include: dashed, dotted, slotted, shaded, 3D, etc.

Block 703. Does an arrow of STYLE and COLOR currently have a designated action or behavior? This is a test to see if an arrow logic has been created for a given color and/or line style. The software searches for a match to the style and color of the drawn arrow to determine if a behavior can be found that has been designated for that color and/or line style. This designation can be a software default or a user-defined parameter.

If the answer to Block 703 is yes, the process proceeds to Block 704. If no, the process proceeds to Block 714.

Block 704. The action for this arrow will be ACTION_{X}, which is determined by the current designated action for a recognized drawn arrow of COLOR and STYLE. If the arrow of STYLE and COLOR does currently have a designated action or behavior, namely, there is an action for this arrow, then the software looks up the available actions and determines that such an action exists (is provided for in the software) for this color and/or style of line when used to draw a recognized arrow. In this step the action of this arrow is determined.

Block 705. Does an action of type ACTION_{X} require a target object for its enactment? The arrow logic for any valid recognized arrow includes as part of the logic a determination of the type(s) and quantities of objects that the arrow logic can be applied to after the recognition of the drawn arrow. This determination of type(s) and quantities of objects is a context for the drawn arrow, which is recognized by the software.

### EXAMPLE 1

Let's say a red arrow is drawn between four (4) faders such that the arrow intersects all four faders. Let's further say the red arrow logic is a “control logic,” namely, the arrow permits the object that it's drawn from to control the object that it's drawn to. Therefore, with this arrow logic of the red arrow, a target is required. Furthermore, the first intersected fader will control the last intersected fader and the faders in between will be ignored. See Blocks 711 and 712 in this flowchart.

### EXAMPLE 2

Let's say a yellow arrow is drawn between four faders, such that the arrow shaft intersects the first three faders and the tip of the arrow intersects the fourth fader. Let's further say that an “assignment” arrow logic is designated for the color yellow, namely, “every object that the arrow intersects will be assigned to the object that arrow points to.” In this case, the arrow logic will be invalid, as a fader cannot be assigned to another fader according to this logic. Whereas, if the same yellow arrow is drawn to intersect four faders and the arrowhead is made to intersect a blue star, the four faders will be assigned to the star.

The behavior of the blue star will be governed by the yellow arrow logic. In this instance, the four faders will disappear from the screen and, from this point on, have their screen presence be determined by the status of the blue star. In other words, they will reappear in their same positions when the blue star is clicked on and then disappear again when the blue star is clicked once more and so on. Furthermore, the behavior of the faders will not be altered by their assignment to the blue star. They still exist on the Global drawing surface as they did before with their same properties and functionality, but they can be hidden by clicking on the blue star to which they have been assigned. Finally, they can be moved to any new location while they are visible and their assignment to the blue star remains intact.

### EXAMPLE 3

Let's say you draw a green arrow which has a “copy” logic assigned to it, which states, “copy the object(s) that the arrow shaft intersects or encircled to the point on the Global Drawing surface (Blackspace) that the tip of the arrowhead points to”. Because of the nature of this arrow logic, no target object is required. What will happen is that the object(s) intersected or encircled by the green arrow will be copied to another location on the Global Drawing surface.

If the answer to Block 705 is yes, the process proceeds to Block 706. If no, the process proceeds to Block 708.

Block 706. Determine the target object TARGETOBJECT for the rendered arrow by analysis of the Blackspace objects which collide or nearly collide with the rendered arrowhead. The software looks at the position of the arrowhead on the global drawing surface and determines which objects, if any, collide with it. The determination of a collision can be set in the software to require an actual intersection or distance from the tip of the arrowhead to the edge of an object that is deemed to be a collision. Furthermore, if no directly colliding objects are found, preference may or not be given to objects which do not collide in close proximity, but which are near to the arrowhead, and are more closely aligned to the direction of the arrowhead than other surrounding objects. In other words, objects which are situated on the axis of the arrowhead may be chosen as targets even though they don't meet a strict “collision” requirement. In all cases, if there is potential conflict as to which object to designate as the target, the object with the highest object layer will be designated. The object with the highest layer is defined as the object that can overlap and overdraw other objects that it intersects.

Block 707. Is the target object (if any) a valid target for an action of the type ACTION_{X}? This step determines if the target object(s) can have the arrow logic (that belongs to the line which has been drawn as an arrow and recognized as such by the software) applied to it. Certain arrow logics require certain types of targets. As mentioned above, a “copy” logic (green arrow) does not require a target. A “control” logic (red arrow) recognizes only the object to which the tip of the arrow is intersecting or nearly intersecting as its target.

If the answer to Block 707 is yes, the process proceeds to Block 708. If no, the process proceeds to Block 710.

Block 708. Assemble a list, SOURCEOBJECTLIST, of all Blackspace objects colliding directly with, or closely with, or which are enclosed by, the rendered arrowshaft. This list includes all objects as they exist on the global drawing surface that are intersected or encircled by or nearly intersected by the drawn and recognized arrow object. They are placed in a list in memory, called for example, the “source object list” for this recognized and rendered arrow.

Block 709. Remove from SOURCEOBJECTLIST, objects which currently or unconditionally indicate they are not valid sources for an action of type ACTION_{X} with the target TARGETOBJECT. Different arrow logics have different conditions in which they recognize objects that they determine as being valid sources for their arrow logic. The software analyzes all source objects on this list and then evaluates each listed object according to the implementation of the arrow logic to these sources and to the target(s), if any. All source objects which are not valid sources for a given arrow logic, which has been drawn between that object and a target object, will be removed from this list.

Block 710. Does SOURCEOBJECTLIST now contain any objects? If any source objects qualify as being valid for the type of arrow logic belonging to the drawn and recognized arrow that intersected or nearly intersected them, and such logic is valid for the type of target object(s) intersected by this arrow, then these source objects will remain in the sourceobjectlist.

If the answer to Block 710 is yes, the process proceeds to Block 711. If no, the process proceeds to Block 714.

Block 711. Does the action “ACTION_{X}” allow multiple source objects? A test is done to query the type of arrow logic belonging to the drawn and recognized arrow to determine if the action of its arrow logic permits multiple source objects to be intersected or nearly intersected by its shaft.

If the answer to Block 711 is yes, the process proceeds to Block 713. If no, the process proceeds to Block 712.

Block 712. Remove from SOURCEOBJECTLIST all objects except the one closest to the rendered arrowshaft start position. In this case, the recognized arrow logic can have only a single source. So the software determines that the colliding object which is closest to the drawn and recognized arrow's start position is the source object and then removes all other source objects that collide with its shaft.

NOTE: Certain types of arrow logics require certain types of sources. For instance, if a red “control” arrow is drawn to intersect four switches and then drawn to point to blank Blackspace surface (an area on the global drawing surface where no objects exist), then no valid sources will exist and no arrow logic will be applied. The “red” logic will be considered invalid. It's invalid because although the source objects are correct for this type of arrow logic, a suitable target object must exist for the “control” logic to be valid in the absence of a context that would override this requirement. If however, this same red arrow is drawn to intersect these same four switches and then the tip of the arrow also intersects or nearly intersects a fifth switch (a valid target for this logic), then the red arrow logic recognizes the first intersected switch only as its source and the last intersected switch only as the target. The other intersected switches that appeared on the “sourceobjectlist” will be removed.

Block 713. Set the rendered arrow as Actionable with the action defined as ACTION_{X}. After Block 712, the required action has been identified and has not been immediately implemented because it awaits an input from a user. As an example, identifying the action would be to have the arrowhead of the drawn and recognized arrow turn white (see Block 715). An example of input from a user would be requiring them to click on the white arrowhead to activate the logic of the drawn and recognized arrow (see Blocks 715-718).

Block 714. Redraw above all existing Blackspace objects an enhanced or “idealized” arrow of COLOR and STYLE in place of the original drawn stroke. If an arrow logic is not deemed to be valid for any reason, the drawn arrow is still recognized, but rendered onscreen as a graphic object only. The rendering of this arrow object includes the redrawing of it by the software in an idealized form as a computer generated arrow with a shaft and arrow head equaling the color and line style that were used to draw the arrow.

Block 715. Redraw above all existing Blackspace objects, an enhanced or “idealized” arrow of COLOR and STYLE with the arrowhead filled white in place of the original drawn stroke. After the arrow logic is deemed to be valid for both its source(s) and target object(s), then the arrowhead of the drawn and recognized arrow will turn white. This lets a user decide if they wish to complete the implementation of the arrow logic for the currently designated source object(s) and target object(s).

Block 716. The user has clicked on the white-filled arrowhead of an Actionable rendered arrow. The user places their mouse cursor over the white arrowhead of the drawn and recognized arrow and then performs a mouse downclick.

Block 717. Perform using ACTION_{X} on source objects “SOURCEOBJECTLIST” with target “TARGETOBJECT” if any. After receiving a mouse downclick on the white arrowhead, the software performs the action of the arrow logic on the source object(s) and the target object(s) as defined by the arrow logic.

Block 718. Remove the rendered arrow from the display. After the arrow logic is performed under Block 717, the arrow is removed from being onscreen and no longer appears on the global drawing surface. This removal is not graphical only. The arrow is removed and no longer exists in time. However, the result of its action being performed on its source and target object(s) remains.

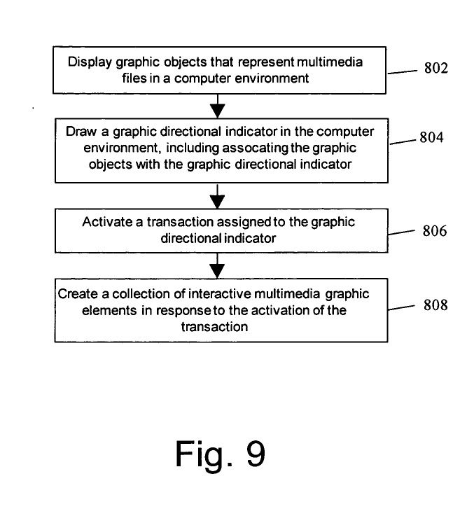

A method for creating a collection of interactive multimedia graphic elements, e.g., thumbnails and sound switches, in accordance with an embodiment of the invention is described with reference to a flow diagram of FIG. 9. At block 802, graphic objects that represent multimedia files are displayed in a computer environment, e.g., a Blackspace environment. Next, at block 804, a graphic directional indicator is drawn in the computer environment. Furthermore, at block 804, the graphic objects are associated with the graphic directional indicator by, for example, drawing the graphic directional indicator that intersects, nearly intersects and/or substantially encircle the graphic objects. Next, at block 806, a transaction assigned to the graphic directional indicator is activated. Next, at block 808, a collection of interactive multimedia graphic elements is created in response to the activation of the transaction assigned to the graphic directional indicator. Each of the interactive multimedia graphic elements is configured to perform an operation on a corresponding multimedia file when that interactive multimedia graphic element is activated.

Although specific embodiments of the invention have been described and illustrated, the invention is not to be limited to the specific forms or arrangements of parts so described and illustrated. The scope of the invention is to be defined by the claims appended hereto and their equivalents.

1. A method for creating a collection of interactive multimedia graphic elements, said method comprising:
displaying graphic objects that represent multimedia files in a computer environment;
drawing a graphic directional indicator in said computer environment, including associating said graphic objects with said graphic directional indicator; and
activating a transaction assigned to said graphic directional indicator; and
creating said collection of interactive multimedia graphic elements in response to said activating of said transaction, each of said interactive multimedia graphic elements being configured to perform an operation on a corresponding multimedia file when activated.

2. A storage medium readable by a computer, tangibly embodying a program of instructions executable by said computer to perform method steps for creating a collection of interactive multimedia graphic elements, said method steps comprising:
displaying graphic objects that represent multimedia files in a computer environment;
drawing a graphic directional indicator in said computer environment, including associating said graphic objects with said graphic directional indicator; and
activating a transaction assigned to said graphic directional indicator; and
creating said collection of interactive multimedia graphic elements in response to said activating of said transaction, each of said interactive multimedia graphic elements being configured to perform an operation on a corresponding multimedia file when activated.
